(19) United States
(12) Patent Application Publication
(10) Pub. No.: US 2026/0302963 A1
(43) Pub. Date: Oct. 1, 2026

(54) SWITCHED-MODE POWER SUPPLY CIRCUIT, SECONDARY CONTROL CIRCUIT, AND ELECTRONIC DEVICE

(71) Applicant: Zhuhai Nanxin Semiconductor Technology Co., Ltd., Zhuhai City (CN)

(72) Inventors: Lin Feng, Zhuhai City (CN); Nan Wang, Zhuhai City (CN)

(21) Appl. No.: 19/630,370

(22) Filed: Mar. 26, 2026

(30) Foreign Application Priority Data
Mar. 26, 2025 (CN) 202510371424.7

(51) Int. Cl. H02M 3/335; H02M 1/32

(52) U.S. Cl. CPC H02M 3/33592; H02M 1/322

(57) ABSTRACT

The disclosure relates to a switched-mode power supply circuit, a secondary control circuit, a chip, and an electronic device. The switched-mode power supply circuit includes a transformer, a secondary control circuit, a secondary transistor, and at least one discharging branch. In a case where no load is electrically connected to a discharging branch of at least one discharging branch, the secondary control circuit controls the discharge circuit to be in conduction to pull down a voltage at an output terminal of the discharging branch. Compared with the switched-mode power supply circuit according to the related art, the switched-mode power supply circuit achieves the technical effects of the load switch, the controller, and the filter circuit in the related art, the structure of the switched-mode power supply circuit is simplified, thereby resulting in a lower hardware cost of the switched-mode power supply circuit.

### CROSS REFERENCE TO THE RELATED APPLICATIONS

This application is based upon and claims priority to Chinese Patent Application No. 202510371424.7, filed on Mar. 26, 2025, the entire contents of which are incorporated herein by reference.

### TECHNICAL FIELD

The present disclosure relates to the technical field of switched-mode power supplies, and in particular, relates to a switched-mode power supply circuit, a secondary control circuit, a chip, and an electronic device.

### BACKGROUND

With the development of electronic technologies, various types of electronic devices are constantly emerging. Different types of electronic devices may have different types of charging interfaces. For accommodation of charging requirements of electronic devices with different types of interfaces, a power adapter is generally provided with two or more different charging interfaces. Each charging interface corresponds to a discharging branch, such that the electronic devices with different charging interfaces may be charged simultaneously. Since different electronic devices include different loads, during simultaneous charging of a plurality of electronic devices, charging voltages outputted by respective discharging branches are generally different. For simultaneous accommodation of charging requirements of the plurality of electronic devices, a multi-output switched-mode power supply has emerged, which has advantages of small volume and low cost.

In a switched-mode power supply circuit according to the related art, a load switch and a controller configured to control the load switch are arranged at an output terminal of each discharging branch. In a case where no load is electrically connected to the output terminal of the discharging branch, the load switch is controlled to be turned off by the controller, to prevent the output terminal of the discharging branch from being energized. However, since the load switch is disposed on the discharging branch, a high-frequency ripple may be output at the output terminal of the discharging branch, which affects stability of a voltage at the output terminal of the discharging branch. Therefore, a filter circuit is generally further required to be disposed at the output terminal of the discharging branch, to filter out the high-frequency ripple caused by the load switch. As a result, the switched-mode power supply circuit in the related art has a complex structure and a relatively high hardware cost.

### SUMMARY

The present disclosure provides a switched-mode power supply circuit, a secondary control circuit, a chip, and an electronic device, to solve the technical problems of a complex structure and a relatively high hardware cost of a switched-mode power supply circuit in the related art.

In one aspect of the embodiments of the present disclosure, a switched-mode power supply circuit is provided. The switched-mode power supply circuit includes: a transformer, a secondary control circuit, a secondary transistor, and at least one discharging branch.

A primary winding of the transformer is configured to receive a supply voltage, a first terminal of a secondary winding of the transformer is electrically connected to an input terminal of each discharging branch of the at least one discharging branch, and an output terminal of the each discharging branch is configured to output a respective discharge voltage.

A second terminal of the secondary winding is electrically connected to a first terminal of the secondary transistor, a second terminal of the secondary transistor is grounded, and a control terminal of the secondary transistor is electrically connected to the secondary control circuit.

Any one discharging branch of the at least one discharging branch includes a switch circuit, an energy storage capacitor, and a discharge circuit, wherein a first terminal of the switch circuit serves as the input terminal of the discharging branch, a second terminal of the switch circuit serves as the output terminal of the discharging branch, a control terminal of the switch circuit is electrically connected to the secondary control circuit, and the secondary control circuit is configured to control the switch circuit to be turned on or turned off.

A first terminal of the energy storage capacitor is electrically connected to the second terminal of the switch circuit, and a second terminal of the energy storage capacitor is grounded; an input terminal of the discharge circuit is electrically connected to the first terminal of the energy storage capacitor, an output terminal of the discharge circuit is grounded, and a control terminal of the discharge circuit is electrically connected to the secondary control circuit; and the secondary control circuit is configured to control the discharge circuit to be in conduction to pull down a voltage at the output terminal of the discharging branch.

In some embodiments, the switched-mode power supply circuit further includes a secondary power supply circuit; wherein an input terminal of the secondary power supply circuit is electrically connected to the first terminal of the secondary winding, and an output terminal of the secondary power supply circuit is electrically connected to a power supply pin of the secondary control circuit.

The secondary power supply circuit is configured to draw power from the first terminal of the secondary winding to supply power to the secondary control circuit.

In some embodiments, the secondary control circuit further includes a control pin, wherein the control pin is electrically connected to a control terminal of the secondary power supply circuit.

The secondary control circuit is further configured to, in response to detecting that a voltage value at the power supply pin reaches a first predetermined voltage, transmit a first control signal to the secondary power supply circuit via the control pin.

In some embodiments, the secondary power supply circuit includes a first diode and a third capacitor; wherein a positive terminal of the first diode is electrically connected to the first terminal of the secondary winding, a negative terminal of the first diode is electrically connected to a first terminal of the third capacitor, and a second terminal of the third capacitor is grounded.

The first terminal of the third capacitor is further electrically connected to a power supply terminal of the secondary control circuit.

In some embodiments, the switched-mode power supply circuit further includes an output detection circuit; wherein sampling terminals of the output detection circuit are respectively electrically connected to the output terminal of the each discharging branch, and an output terminal of the output detection circuit is electrically connected to the secondary control circuit.

The output detection circuit is configured to detect whether a load is electrically connected to the output terminal of the discharging branch, and output a detection result to the secondary control circuit; and the secondary control circuit is configured to, in response to determining that no load is electrically connected to the output terminal of the discharging branch, control the switch circuit on the discharging branch to be in non-conduction, and control the discharge circuit on the discharging branch to be in conduction.

In some embodiments, the output detection circuit is further configured to detect at least one of a load voltage and a load current at the output terminal of the discharging branch, and then output a detection result to the secondary control circuit.

The secondary control circuit is further configured to, in response to determining that the at least one of the load voltage and the load current reaches a corresponding threshold, control the switch circuit on the discharging branch to be in non-conduction, and simultaneously control the discharge circuit on the discharging branch to be in conduction.

In some embodiments, the switched-mode power supply circuit further includes a primary transistor and a primary control circuit; wherein a first terminal of the primary winding of the transformer is configured to receive the supply voltage, a second terminal of the primary winding is electrically connected to a first terminal of the primary transistor, and a second terminal of the primary transistor is grounded; and a control terminal of the primary transistor is electrically connected to the primary control circuit, and the primary control circuit is configured to control the primary transistor to be turned on or turned off.

In some embodiments, the switched-mode power supply circuit further includes an isolated communication circuit; wherein the primary control circuit is electrically connected to the secondary control circuit via the isolated communication circuit.

The secondary control circuit is further configured to, in a case where no load is electrically connected to the output terminals of all discharging branches, determine whether a voltage value at a power supply pin of the secondary control circuit is greater than a first predetermined voltage, and output a second control signal to the primary control circuit via the isolated communication circuit in a case where the voltage value at the power supply pin is greater than the first predetermined voltage; and the primary control circuit is further configured to control the primary transistor to be turned off in response to the second control signal.

The secondary control circuit is further configured to, in a case where no load is electrically connected to the output terminals of all discharging branches, determine whether the voltage value at the power supply pin of the secondary control circuit is less than a second predetermined voltage, and output a third control signal to the primary control circuit via the isolated communication circuit in a case where the voltage value at the power supply pin is less than the second predetermined voltage; and the primary control circuit is configured to control the primary transistor to be turned on in response to the third control signal.

In some embodiments, the switch circuit includes a fifth transistor and a sixth transistor; wherein a first terminal of the fifth transistor is electrically connected to the first terminal of the secondary winding of the transformer, a second terminal of the fifth transistor is electrically connected to a second terminal of the sixth transistor, and a first terminal of the sixth transistor is electrically connected to the first terminal of the energy storage capacitor; control terminals of the fifth transistor and the sixth transistor are both electrically connected to a drive pin on the secondary control circuit; and the secondary control circuit is configured to control the fifth transistor and the sixth transistor to be turned on or turned off.

In a second aspect of the embodiments of the present disclosure, a secondary control circuit is provided. The secondary control circuit is applicable to a switched-mode power supply circuit, wherein the switched-mode power supply circuit includes a transformer, a secondary transistor, and at least one discharging branch; wherein a primary winding of the transformer is configured to receive a supply voltage, a first terminal of a secondary winding of the transformer is electrically connected to an input terminal of each discharging branch of the at least one discharging branch, and an output terminal of the each discharging branch is configured to output a respective discharge voltage; a second terminal of the secondary winding is electrically connected to a first terminal of the secondary transistor, a second terminal of the secondary transistor is grounded, and a control terminal of the secondary transistor is electrically connected to the secondary control circuit; any one discharging branch of the at least one discharging branch includes a switch circuit, an energy storage capacitor, and a discharge circuit, wherein a first terminal of the switch circuit serves the input terminal of the discharging branch, a second terminal of the switch circuit serves as the output terminal of the discharging branch, and a control terminal of the switch circuit is electrically connected to the secondary control circuit; a first terminal of the energy storage capacitor is electrically connected to the second terminal of the switch circuit, and a second terminal of the energy storage capacitor is grounded; and an input terminal of the discharge circuit is electrically connected to the first terminal of the energy storage capacitor, an output terminal of the discharge circuit is grounded, and a control terminal of the discharge circuit is electrically connected to the secondary control circuit.

The secondary control circuit is configured to, in response to detecting that no load is electrically connected to an output terminal of a target discharging branch of the at least one discharging branch, control a switch circuit on the target discharging branch to be in non-conduction, and simultaneously control a discharge circuit on the target discharging branch to be in conduction, such that residual charge in the target discharging branch is bled off.

In some embodiments, the secondary control circuit is further configured to: acquire a load condition at the output terminal of each discharging branch of the at least one discharging branch, determine an energy ratio required by the each discharging branch electrically connected to a load, and control an on-time duty ratio of the switch circuit on the each discharging branch electrically connected to the load based on the energy ratio, to adjust a discharge power at the output terminal of the each discharging branch.

In a third aspect of the embodiments of the present disclosure, a chip is further provided. The chip includes the switched-mode power supply circuit as described above, or the secondary control chip as described above.

In a fourth aspect of the embodiments of the present disclosure, an electronic device is further provided. The electronic device includes the switched-mode power supply circuit as described above, or the chip as described above.

The switched-mode power supply circuit according to the first aspect includes a transformer, a secondary control circuit, a secondary transistor, and at least one discharging branch. A primary winding of the transformer is configured to receive a supply voltage, a first terminal of a secondary winding of the transformer is electrically connected to an input terminal of the discharging branch, an output terminal of the discharging branch is configured to output a discharge voltage, a second terminal of the secondary winding is electrically connected to a first terminal of the secondary transistor, a second terminal of the secondary transistor is grounded, and a control terminal of the secondary transistor is electrically connected to the secondary control circuit. The discharging branch includes a switch circuit, an energy storage capacitor, and a discharge circuit. A first terminal of the switch circuit serves as the input terminal of the discharging branch, a second terminal of the switch circuit serves as the output terminal of the discharging branch, and a control terminal of the switch circuit is further electrically connected to the secondary control circuit. The secondary control circuit is configured to control the switch circuit to be in conduction or in non-conduction. A first terminal of the first capacitor is electrically connected to the second terminal of the switch circuit, a second terminal of the first capacitor is grounded, an input terminal of the discharge circuit is electrically connected to the first terminal of the first capacitor, an output terminal of the discharge circuit is grounded, and a control terminal of the discharge circuit is further electrically connected to the secondary control circuit. The secondary control circuit is configured to control the discharge circuit to be in conduction to pull down a voltage at the output terminal of the discharging branch. Compared with the switched-mode power supply circuit according to the related art, the switched-mode power supply circuit according to the present disclosure is provided with the discharge circuit, such that the technical effects of the load switch, the controller, and the filter circuit in the related art are achieved, the structure of the switched-mode power supply circuit is simplified, thereby resulting in a lower hardware cost of the switched-mode power supply circuit.

For details about the beneficial effects achieved by the method according to the second aspect and the embodiments of the second aspect, reference may be made to the beneficial effects achieved by the first aspect or any embodiment of the first aspect, which are not described herein any further.

### BRIEF DESCRIPTION OF DRAWINGS

FIG. 1 is a schematic structural diagram of a switched-mode power supply circuit in the related art.

FIG. 2 is a schematic structural diagram of a switched-mode power supply circuit according to an embodiment of the present disclosure.

FIG. 3 is a schematic structural diagram of a switched-mode power supply circuit according to an embodiment of the present disclosure.

FIG. 4 is a schematic structural diagram of a switched-mode power supply circuit according to an embodiment of the present disclosure.

FIG. 5 is a schematic structural diagram of a switched-mode power supply circuit according to an embodiment of the present disclosure.

FIG. 6 is a schematic structural diagram of an output detection circuit according to an embodiment of the present disclosure.

FIG. 7 is a schematic structural diagram of a switched-mode power supply circuit according to an embodiment of the present disclosure.

FIG. 8 is a schematic structural diagram of a switched-mode power supply circuit according to an embodiment of the present disclosure.

### DETAILED DESCRIPTION OF THE EMBODIMENTS

In the present disclosure, the term "at least one" refers to one or more than one, and the term "a plurality of" refers to two or more than two. The term "and/or" is merely an association relationship for describing associated objects, which represents that there may exist three types of relationships. For example, the phrase "A and/or B" means (A), (B), or (A and B), wherein A and B may be single or plural. In addition, the symbol "/" generally represents an "or" relationship between associated objects before and after the symbol. The expression "at least one of the following" or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms "first," "second," and the like are merely for the illustration purpose, and shall not be construed as indicating or implying a relative importance.

In the description of the present disclosure, it should be understood that the terms "central," "transversal," "longitudinal," "upper," "lower," "left," "right," "front," "rear," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms "connected," "coupled," and derivatives forms thereof shall be understood in a broad sense. For example, the terms "connected," "coupled," and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

The transistors according to the embodiments of the present disclosure are all three-terminal transistors. For example, each of the transistors has a control terminal, a first terminal, and a second terminal. The transistors may be bipolar transistors or field-effect transistors. For example, in a case where the transistor is a bipolar transistor, the control terminal of the transistor refers to a base of the bipolar transistor, the first terminal refers to a collector or an emitter of the bipolar transistor, and the second terminal refers to an emitter or a collector; or in a case where the transistor is a field-effect transistor, the control terminal of the transistor refers to a gate of the field-effect transistor, the first terminal of the transistor refers to a drain or a source of the field-effect transistor, and the second terminal of the transistor is a source or drain of the field-effect switching transistor.

With the development of electronic technologies, charging efficiency and charging safety of electronic devices have become a major concern for people. In the related art, a switched-mode power supply circuit used for fast charging of an electronic device typically includes a transformer, a primary switching transistor, a secondary switching transistor, a primary control unit, and a secondary control unit. The primary switching transistor is disposed in a primary winding loop of the transformer, and the secondary switching transistor is disposed in a secondary winding loop of the transformer. The transformer is configured to convert an inputted supply voltage, such that the secondary winding outputs a charging voltage compatible with the electronic device. The primary control unit and the secondary control unit are respectively configured to control the primary switching transistor and the secondary switching transistor to be turned on or turned off, such that the switched-mode power supply circuit is controlled to operate in different charging modes to meet charging requirements in various scenarios.

Currently, different types of electronic devices in the market may have different charging interface types. For accommodation of charging requirements of electronic devices with different types of interfaces, a power adapter is generally provided with two or more different charging interfaces. Each charging interface corresponds to a discharging branch, such that the electronic devices with different charging interfaces may be charged simultaneously. For example, a fast charging adapter may simultaneously achieve two outputs. One output may supply power to an electronic device having a USB type-C interface, and the other output may charge an electronic device having a USB type-A interface, and the two outputs simultaneously charge the two electronic devices without affecting each other.

In a switched-mode power supply circuit according to the related art, a load switch and a controller configured to control the load switch are arranged at an output terminal of each discharging branch. In a case where no load is electrically connected to the output terminal of the discharging branch, the load switch is controlled to be turned off by the controller, to prevent the output terminal of the discharging branch from being energized. However, since the load switch is disposed on the discharging branch, a high-frequency ripple may be output at the output terminal of the discharging branch, which affects stability of a voltage at the output terminal of the discharging branch. Therefore, a filter circuit is generally further required to be disposed at the output terminal of the discharging branch, to filter out the high-frequency ripple caused by the load switch. As a result, the switched-mode power supply circuit in the related art has a complex structure and a relatively high hardware cost.

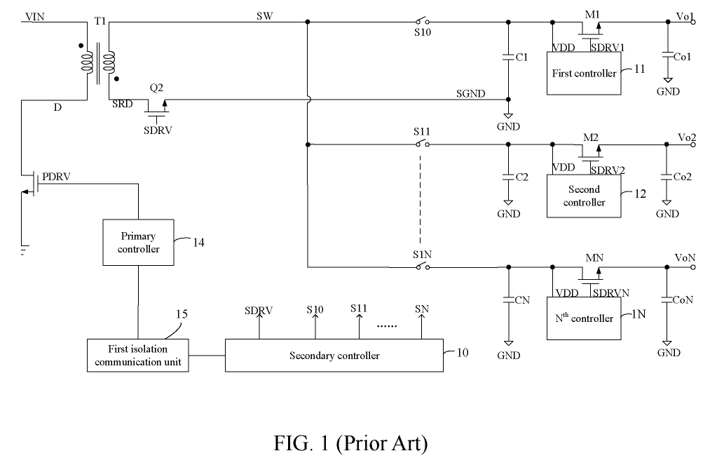

FIG. 1 is a schematic structural diagram of a switched-mode power supply circuit in the related art. Referring to FIG. 1, the switched-mode power supply circuit includes a first transformer T1, a first transistor Q1, a second transistor Q2, a primary controller 14, a secondary controller 10, and a plurality of discharging branches.

The first transistor Q1 is disposed in a primary winding loop of the first transformer T1. Specifically, a first terminal of the first transistor Q1 is electrically connected to an undotted terminal of the primary winding, and a dotted terminal of the primary winding is configured to receive a supply voltage VIN. A second terminal of the first transistor Q1 is grounded, and a control terminal of the first transistor Q1 is electrically connected to the primary controller 14. The primary controller 14 is configured to control the first transistor Q1 to be turned on or turned off, thereby controlling whether the primary winding outputs energy to the secondary winding.

The second transistor Q2 is disposed in a secondary winding loop of the first transformer T1. Specifically, a first terminal of the second transistor Q2 is electrically connected to a dotted terminal of the secondary winding of the first transformer T1, a second terminal of the second transistor Q2 is grounded, and a control terminal SDRV of the second transistor Q2 is electrically connected to the secondary controller 10. An undotted terminal of the secondary winding of the first transformer T1 is electrically connected to an input terminal of each discharging branch, and an output terminal of the each discharging branch is configured to connect to a load, to supply power to the load. The first transformer T1 is configured to convert the inputted supply voltage, such that the secondary winding outputs a charging voltage compatible with the electronic device. The primary controller 14 and the secondary controller 10 are respectively configured to control the first transistor Q1 and the second transistor Q2 to be turned on or turned off, thereby controlling the switched-mode power supply circuit to operate in different charging modes, to meet charging requirements in various scenarios.

The switched-mode power supply circuit further includes a first isolation communication unit 15, and the primary controller 14 is electrically connected to the secondary controller 10 via the first isolation communication unit 15. It can be understood that, in an isolated switched-mode power supply circuit, the first isolation communication unit 15 mainly achieves the effects in terms of safety, stability, and noise isolation to ensure stable operation of the switched-mode power supply, which is not described herein any further.

The first transistor Q1 and the second transistor Q2 in the switched-mode power supply circuit according to this embodiment may both adopt n-metal-oxide-semiconductor (NMOS) transistors. In other embodiments, the first transistor Q1 and the second transistor Q2 may also adopt p-metal-oxide-semiconductor (PMOS) transistors. For example, in a case where the first transistor Q1 and the second transistor Q2 adopt NMOS transistors, first terminals thereof are drains, second terminals thereof are sources, and control terminals thereof are gates. In addition, the NMOS transistors according to this embodiment may adopt power devices such as metal-oxide-semiconductor field-effect transistors (MOSFETs), GaN transistors, and SiC transistors, which are not limited herein.

Still referring to FIG. 1, the switched-mode power supply circuit in the related art includes a plurality of charging output terminals. A controllable switch, an energy storage capacitor, a load switch, a controller, and a filter capacitor are arranged on each discharging branch. The undotted terminal of the secondary winding of the first transformer T1 serves as a high-voltage terminal, and the undotted terminal of the secondary winding is electrically connected to the input terminal of each discharging branch, to output electrical energy to each discharging branch respectively. During operation, the secondary controller 10 controls, based on a duty cycle signal, the controllable switch on each discharging branch to be turned on or turned off, thereby controlling an energy ratio outputted on each discharging branch, and achieving regulation of the plurality of discharging branches without affecting each other.

Specifically, the switched-mode power supply circuit according to this embodiment includes N discharging branches, wherein N is an integer greater than or equal to 1. For example, a first discharging branch, a second discharging branch, ..., and an N^{th} discharging branch. The undotted terminal of the secondary winding is electrically connected to input terminals of the first discharging branch, the second discharging branch, ..., and the N^{th} discharging branch respectively.

For example, the first discharging branch includes a first controllable switch S10, a first energy storage capacitor C1, a first load switch M1, a first controller 11, and a first filter capacitor Co1. A first terminal of the first controllable switch S10 is electrically connected to the undotted terminal of the secondary winding, a second terminal of the first controllable switch S10 is electrically connected to a first terminal of the first energy storage capacitor C1, a second terminal of the first energy storage capacitor C1 is grounded, and a control terminal of the first controllable switch S10 is electrically connected to a control pin of the secondary controller 10. The secondary controller 10 is configured to control the first controllable switch S10 to be turned on or turned off. The second terminal of the first controllable switch S10 is further electrically connected to a first terminal of the first load switch M1. A second terminal of the first load switch M1 serves as the output terminal of the first discharging branch to output a discharge voltage Vo1 of the first discharging branch, and a control terminal SDRV1 of the first load switch M1 is electrically connected to a control pin of the first controller 11. The first controller 11 is configured to control the first load switch M1 to be turned on or turned off. The second terminal of the first load switch M1 is further electrically connected to a first terminal of the first filter capacitor Co1, and a second terminal of the first filter capacitor Co1 is grounded. In addition, a power supply pin VDD of the first controller 11 is further electrically connected to the first terminal of the first energy storage capacitor C1, to supply power to the first controller 11.

Correspondingly, the second discharging branch includes a second controllable switch S11, a second energy storage capacitor C2, a second load switch M2, a second controller 12, and a second filter capacitor Co2. A first terminal of the second controllable switch S11 is electrically connected to the undotted terminal of the secondary winding, a second terminal of the second controllable switch S11 is electrically connected to a first terminal of the second energy storage capacitor C2, and a control terminal of the second controllable switch S11 is electrically connected to a control pin of the secondary controller. The secondary controller 10 is configured to control the second controllable switch S11 to be turned on or turned off. A second terminal of the second energy storage capacitor C2 is grounded, the second terminal of the second controllable switch S11 is further electrically connected to a first terminal of the second load switch M2, a second terminal of the second load switch M2 serves as the output terminal of the second discharging branch to output a discharge voltage Vo2 of the second discharging branch, and a control terminal SDRV2 of the second load switch M2 is electrically connected to a control pin of the second controller 12. The second controller 12 is configured to control the second load switch M2 to be turned on or turned off. The second terminal of the second load switch M2 is further electrically connected to a first terminal of the second filter capacitor Co2, and a second terminal of the second filter capacitor Co2 is grounded. In addition, a power supply pin VDD of the second controller 12 is further electrically connected to the first terminal of the second energy storage capacitor C2, to supply power to the second controller 12.

A circuit structure of the N^{th} discharging branch is the same as the circuit structures of the first discharging branch and the second discharging branch, and N is an integer greater than or equal to 3.

For example, the N^{th} discharging branch includes an N^{th} controllable switch SN, an N^{th} energy storage capacitor CN, an N^{th} load switch MN, an N^{th} controller 1N, and an N^{th} filter capacitor CoN. A first terminal of the N^{th} controllable switch SN is electrically connected to the undotted terminal of the secondary winding, a second terminal of the N^{th} controllable switch SN is electrically connected to a first terminal of the N^{th} energy storage capacitor CN, and a control terminal of the N^{th} controllable switch SN is electrically connected to a control pin of the secondary controller 10. The secondary controller 10 is configured to control the N^{th} controllable switch SN to be turned on or turned off. A second terminal of the N^{th} energy storage capacitor CN is grounded, the second terminal of the N^{th} controllable switch SN is further electrically connected to a first terminal of the N^{th} load switch MN, a second terminal of the N^{th} load switch MN serves as the output terminal of the N^{th} discharging branch to output a discharge voltage VoN of the N^{th} discharging branch, and a control terminal SDRVN of the N^{th} load switch MN is electrically connected to a control pin of the N^{th} controller 1N. The N^{th} controller 1N is configured to control the N^{th} load switch MN to be turned on or turned off. The second terminal of the N^{th} load switch MN is further electrically connected to a first terminal of the N^{th} filter capacitor CoN, and a second terminal of the N^{th} filter capacitor CoN is grounded. In addition, a power supply pin VDD of the N^{th} controller 1N is further electrically connected to the first terminal of the N^{th} energy storage capacitor CN, to supply power to the N^{th} controller 1N.

The load switch on each discharging branch according to this embodiment may be implemented by an NMOS transistor or other power transistors. For example, in a case where the first load switch M1 and the second load switch M2 adopt NMOS transistors, first terminals thereof are drains, second terminals thereof are sources, and control terminals thereof are gates. In addition, the NMOS transistors according to this embodiment may adopt power devices such as MOSFETs, GaN transistors, and SiC transistors, which are not limited herein.

During operation of the switched-mode power supply circuit in the related art in FIG. 1, in a case where no load is electrically connected to an output terminal of a discharging branch, the discharging branch needs to be disconnected. Taking the first discharging branch as an example, in a case where it is detected that no load is electrically connected to the output terminal of the first discharging branch, the secondary controller 10 first controls the first controllable switch S10 of the first discharging branch to be turned off. Since the first energy storage capacitor C1 is charged in a case where the first controllable switch S10 is turned on, the first energy storage capacitor C1 may still discharge outward even in a case where the first controllable switch S10 is turned off, causing the output terminal of the first discharging branch to remain energized, which affects safe and stable operation of the switched-mode power supply circuit. To address this technical defect, in the related art, the first load switch M1 is disposed between the first energy storage capacitor C1 and the output terminal of the first discharging branch. While controlling the first controllable switch S10 to be turned off, the first controller 11 simultaneously controls the first load switch M1 to be turned off to pull down a voltage at the output terminal of the first discharging branch, thereby preventing the output terminal of the first discharging branch from being energized. However, during operation, the first load switch M1 causes a high-frequency ripple to be output at the output terminal of the first discharging branch, which affects stability of the voltage at the output terminal of the first discharging branch. Therefore, in the related art, the first filter capacitor Co1 is generally disposed at the output terminal of the first discharging branch to filter out the high-frequency ripple caused by the first load switch M1.

It may be understood that, based on the switched-mode power supply circuit in the related art in FIG. 1, the controller of each discharging branch needs to draw power from the discharging branch during operation to ensure that the controller operates normally. Therefore, in some application scenarios, the controllable switch of the discharging branch needs to be closed (turned off) to maintain a voltage at the power supply pin VDD of the controller on the discharging branch. In this case, the output terminal of the discharging branch has a voltage, thereby causing the output terminal of the discharging branch to be energized, which poses a safety hazard. To eliminate this safety hazard, in the related art, a load switch needs to be disposed between the second terminal of the controllable switch and the output terminal of the discharging branch, to electrically isolate the second terminal of the controllable switch from the output terminal of the discharging branch.

In addition, in other embodiments, the controller of the discharging branch further includes other peripheral circuits related to the switched-mode power supply circuit. The other peripheral circuits also require real-time power supply during operation. Therefore, even in a case where no load is electrically connected to the output terminal of the discharging branch, the controllable switch on the discharging branch may not continuously maintain a turn-off state. Without the presence of the load switch, in a case where the controllable switch on the discharging branch is closed (turned on) to supply power to the controller, the output terminal of the discharging branch is also in a high-voltage energized state. Therefore, a load switch needs to be disposed between the second terminal of the controllable switch and the output terminal of the discharging branch, to electrically isolate the second terminal of the controllable switch from the output terminal of the discharging branch.

For example, taking the structure of the first discharging branch in the switched-mode power supply circuit illustrated in FIG. 1 as an example, the first controller 11 of the first discharging branch is mainly configured to control the first load switch M1 to be turned on or turned off. During operation, the first controller 11 of the first discharging branch needs to draw power from the first discharging branch, to ensure that the first controller 11 operates normally. Meanwhile, the first controller 11 further includes other peripheral circuits related to the switched-mode power supply circuit; and therefore, the first controller 11 may not operate in a power-off state for a long time. Therefore, in some application scenarios, the first controllable switch S10 on the discharging branch needs to be closed (turned on) to supply power to the first controller 11 on the first discharging branch, such that the voltage on the power supply pin VDD of the first controller 11 satisfies an operational requirement. In this way, the output terminal of the first discharging branch has a voltage, thereby causing the output terminal of the first discharging branch to be energized, which poses a safety hazard. To eliminate this safety hazard, in the related art, the first load switch M1 needs to be disposed between the second terminal of the first controllable switch S10 and the output terminal of the first discharging branch, to electrically isolate the second terminal of the first controllable switch S10 from the output terminal of the first discharging branch.

It may be understood that, circuit structures and operational procedures of the second discharging branch and the remaining respective discharging branches in FIG. 1 according to this embodiment are the same as those of the first discharging branch, which are not described herein any further.

Although the switched-mode power supply circuit in the related art may achieve a plurality of discharging branch outputs, a load switch, a controller, and a filter capacitor need to be introduced on each discharging branch, resulting in a complex structure and a relatively high hardware cost of the switched-mode power supply circuit in the related art.

In addition, since a load switch is introduced on each discharging branch in the switched-mode power supply circuit in the related art, in a case where the controllable switch on the discharging branch is closed (turned on) to supply power to the controller, the load switch also consumes some thermal loss, resulting in a low overall efficiency of the switched-mode power supply circuit.

To overcome the above-mentioned deficiencies in the related art, the present disclosure provides a switched-mode power supply circuit. To simplify the circuit structure and save the hardware cost, in the switched-mode power supply circuit according to the present disclosure, a discharge circuit is disposed on each discharging branch. In a case where no load is electrically connected to an output terminal of a discharging branch, the secondary control circuit controls the discharge circuit to bleed off the residual charge in the discharging branch. This prevents the output terminal of the discharging branch from being energized, and ensures operational safety and stability of the switched-mode power supply circuit. By arranging a discharge circuit, the present disclosure achieves the technical effects of the load switch, the controller, and the filter circuit in the related art, thereby simplifying the circuit structure of the switched-mode power supply circuit. In this way, the hardware cost of the switched-mode power supply circuit is lower. In addition, no load switch needs to be disposed in the discharge circuit according to the present disclosure. This prevents thermal loss generated during operation of the load switch, and improves the overall operational efficiency of the switched-mode power supply circuit.

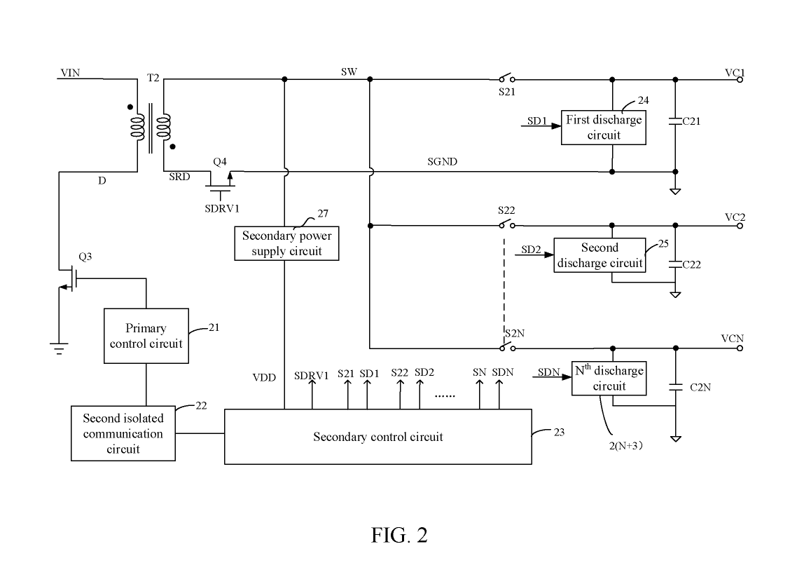

FIG. 2 is a first schematic structural diagram of a switched-mode power supply circuit according to an embodiment of the present disclosure. Referring to FIG. 2, the switched-mode power supply circuit according to this embodiment includes a second transformer T2, a primary transistor Q3, a primary control circuit 21, a secondary control circuit 23, a secondary transistor Q4, and a plurality of discharging branches.

The primary transistor Q3 is disposed in a primary winding loop of the second transformer T2. Specifically, a first terminal of the primary transistor Q3 is electrically connected to a first terminal of the primary winding, and a second terminal of the primary winding is configured to receive a supply voltage VIN. A second terminal of the primary transistor Q3 is grounded, and a control terminal of the primary transistor Q3 is electrically connected to the primary control circuit 21. The primary control circuit 21 is configured to control the primary transistor Q3 to be turned on or turned off, thereby controlling whether the primary winding outputs energy to the secondary winding.

A first terminal of a secondary winding of the second transformer T2 is electrically connected to an input terminal of each discharging branch of the plurality of discharging branches, and an output terminal of each discharging branch is configured to output a discharge voltage. A second terminal of the secondary winding of the second transformer T2 is electrically connected to a first terminal of the secondary transistor Q4, a second terminal of the secondary transistor Q4 is grounded, and a control terminal SDRV1 of the secondary transistor Q4 is electrically connected to a control pin of the secondary control circuit 23.

Each discharging branch according to this embodiment includes a switch circuit, an energy storage capacitor, and a discharge circuit. A first terminal of the switch circuit serves as the input terminal of the discharging branch, a second terminal of the switch circuit serves as the output terminal of the discharging branch, and a control terminal of the switch circuit is further electrically connected to the secondary control circuit 23. The secondary control circuit 23 is configured to control conduction or non-conduction of the switch circuit on the discharging branch, thereby controlling conduction or non-conduction of the discharging branch. A first terminal of the energy storage capacitor is electrically connected to the second terminal of the switch circuit, and a second terminal of the energy storage capacitor is grounded. An input terminal of the discharge circuit is electrically connected to the first terminal of the energy storage capacitor, an output terminal of the discharge circuit is grounded, and a control terminal of the discharge circuit is further electrically connected to the secondary control circuit 23. The secondary control circuit 23 is configured to control the discharge circuit to be in conduction to pull down a voltage at the output terminal of the discharging branch.

According to the switched-mode power supply circuit according to this embodiment, a discharge circuit is disposed on each discharging branch. In a case where no load is electrically connected to an output terminal of a discharging branch, the secondary control circuit controls the discharge circuit to be in conduction to bleed off the residual charge in the discharging branch. This prevents the output terminal of the discharging branch from being energized, and ensures operational safety and stability of the switched-mode power supply circuit. By arranging a discharge circuit, the present disclosure achieves the technical effects of the load switch, the controller, and the filter circuit in the related art, thereby simplifying the circuit structure of the switched-mode power supply circuit. In this way, the hardware cost of the switched-mode power supply circuit is lower. In addition, no load switch needs to be disposed in the discharge circuit according to the present disclosure. This prevents thermal loss generated during operation of the load switch, and improves the overall operational efficiency of the switched-mode power supply circuit.

Still referring to FIG. 2, the switched-mode power supply circuit according to this embodiment includes N discharging branches, wherein N is an integer greater than or equal to 1. For example, the switched-mode power supply circuit includes a first discharging branch, a second discharging branch, ..., and an N^{th} discharging branch.

For example, the first discharging branch includes a first switch circuit S21, a first capacitor C21, and a first discharge circuit 24. A first terminal of the first switch circuit S21 is electrically connected to the first terminal of the secondary winding of the second transformer T2, a second terminal of the first switch circuit S21 is electrically connected to a first terminal of the first capacitor C21, and a second terminal of the first capacitor C21 is grounded. The second terminal of the first switch circuit S21 serves as an output terminal of the first discharging branch, and is configured to output a discharge voltage VC1 of the first discharging branch. A control terminal of the first switch circuit S21 is electrically connected to a control pin of the secondary control circuit 23. The secondary control circuit 23 is configured to output a drive control signal to the control terminal of the first switch circuit S21 to control conduction or non-conduction of the first switch circuit S21, thereby controlling conduction or non-conduction of the first discharging branch. An input terminal of the first discharge circuit 24 is electrically connected to the first terminal of the first capacitor C21, an output terminal of the first discharge circuit 24 is grounded, and a control terminal SD1 of the first discharge circuit 24 is further electrically connected to a corresponding control pin on the secondary control circuit 23. The secondary control circuit 23 is configured to output a corresponding control signal to the control terminal SD1 of the first discharge circuit 24 to control conduction or non-conduction of the first discharge circuit 24. In a case where the first discharge circuit 24 is in conduction, the first discharge circuit 24 may form a current discharge path to release energy stored in the first capacitor C21, thereby pulling down a voltage at the first terminal of the first capacitor C21, and preventing the output terminal of the first discharging branch from being energized.

The second discharging branch according to this embodiment includes a second switch circuit S22, a second capacitor C22, and a second discharge circuit 25. A first terminal of the second switch circuit S22 is electrically connected to the first terminal of the secondary winding of the second transformer T2, a second terminal of the second switch circuit S22 is electrically connected to a first terminal of the second capacitor C22, and a second terminal of the second capacitor C22 is grounded. The second terminal of the second switch circuit S22 serves as an output terminal of the second discharging branch, and is configured to output a discharge voltage VC2 of the second discharging branch. A control terminal of the second switch circuit S22 is electrically connected to a corresponding control pin of the secondary control circuit 23. The secondary control circuit 23 is configured to output a drive control signal to the control terminal of the second switch circuit S22 to control conduction or non-conduction of the second switch circuit S22, thereby controlling conduction or non-conduction of the second discharging branch. An input terminal of the second discharge circuit 25 is electrically connected to the first terminal of the second capacitor C22, an output terminal of the second discharge circuit 25 is grounded, and a control terminal SD2 of the second discharge circuit 25 is further electrically connected to a corresponding control pin on the secondary control circuit 23. The secondary control circuit 23 is configured to output a corresponding control signal to the control terminal SD2 of the second discharge circuit 25 to control conduction or non-conduction of the second discharge circuit 25. In a case where the second discharge circuit 25 is in conduction, the second discharge circuit 25 may form a current discharge path to release energy stored in the second capacitor C22, thereby pulling down a voltage at the first terminal of the second capacitor C22, and preventing the output terminal of the second discharging branch from being in a high-voltage state and being energized.

It should be noted that, in this embodiment, a circuit structure of the N^{th} discharging branch is the same as the circuit structures of the first discharging branch and the second discharging branch as described above. For example, N is an integer greater than or equal to 3.

For example, the N^{th} discharging branch includes an N^{th} switch circuit S2N, an N^{th} capacitor C2N, and an N^{th} discharge circuit 2(N+3). A first terminal of the N^{th} switch circuit S2N is electrically connected to the first terminal of the secondary winding of the second transformer T2, a second terminal of the N^{th} switch circuit S2N is electrically connected to a first terminal of the N^{th} capacitor C2N, and a second terminal of the N^{th} capacitor C2N is grounded. The second terminal of the N^{th} switch circuit S2N serves as an output terminal of the N^{th} discharging branch, and is configured to output a discharge voltage VCN of the N^{th} discharging branch. A control terminal of the N^{th} switch circuit S2N is electrically connected to a control pin on the secondary control circuit 23. The secondary control circuit 23 is configured to output a drive control signal to the control terminal of the N^{th} switch circuit S2N to control conduction or non-conduction of the N^{th} switch circuit S2N, thereby controlling conduction or non-conduction of the N^{th} discharging branch. An input terminal of the N^{th} discharge circuit 2(N+3) is electrically connected to the first terminal of the N^{th} capacitor C2N, an output terminal of the N^{th} discharge circuit 2(N+3) is grounded, and a control terminal SDN of the N^{th} discharge circuit 2(N+3) is further electrically connected to a corresponding control pin on the secondary control circuit 23. The secondary control circuit 23 is configured to output a corresponding control signal to the control terminal SDN of the N^{th} discharge circuit 2(N+3) to control conduction or non-conduction of the N^{th} discharge circuit 2(N+3). In a case where the N^{th} discharge circuit 2(N+3) is in conduction, the N^{th} discharge circuit 2(N+3) may form a current discharge path to release energy stored in the N^{th} capacitor C2N, thereby pulling down a voltage at the first terminal of the N^{th} capacitor C2N, and preventing the output terminal of the N^{th} discharging branch from being energized.

It should be noted that the primary transistor Q3 and the secondary transistor Q4 in the switched-mode power supply circuit according to this embodiment may both adopt NMOS transistors. In other embodiments, the primary transistor Q3 and the secondary transistor Q4 may also adopt PMOS transistors. For example, in a case where the primary transistor Q3 and the secondary transistor Q4 both adopt NMOS transistors, first terminals thereof are drains, second terminals thereof are sources, and control terminals thereof are gates. In addition, the primary transistor Q3 and the secondary transistor Q4 according to this embodiment may adopt power devices such as MOSFETs, GaN transistors, and SiC transistors, which are not limited herein.

It should be noted that, in this embodiment, the first terminal of the primary winding of the second transformer T2 is a dotted terminal, and the second terminal of the primary winding is an undotted terminal; and the first terminal of the secondary winding of the second transformer T2 is an undotted terminal, and the second terminal of the secondary winding of the second transformer T2 is a dotted terminal. In other embodiments, the first terminal of the primary winding of the second transformer T2 may alternatively be an undotted terminal, and the second terminal of the primary winding of the second transformer T2 may be a dotted terminal; and the first terminal of the secondary winding of the second transformer T2 may be a dotted terminal, and the second terminal of the secondary winding of the second transformer T2 may be an undotted terminal.

In the switched-mode power supply circuit according to this embodiment, in an application scenario, in a case where the secondary control circuit 23 detects that a load is electrically connected to the output terminal of the first discharging branch, the secondary control circuit 23 transmits a control signal to the first switch circuit S21 of the first discharging branch to control the first switch circuit S21 to be in conduction, such that the first discharging branch is in conduction, thereby enabling the undotted terminal of the secondary winding of the second transformer T2 to supply power to the first discharging branch. Meanwhile, a high voltage outputted by the undotted terminal of the secondary winding of the second transformer T2 also charges the first capacitor C21, such that the first capacitor C21 stores energy. In a case where the load at the output terminal of the first discharging branch is disconnected, that is, in a case where the secondary control circuit 23 detects that no load is electrically connected to the output terminal of the first discharging branch, the secondary control circuit 23 transmits a control signal to the first switch circuit S21 of the first discharging branch to control the first switch circuit S21 to be in non-conduction, such that the undotted terminal of the secondary winding of the second transformer T2 stops supplying power to the first discharging branch. In this case, since an amount of electrical energy still exists on the first capacitor C21, and non-conduction of the first switch circuit S21 does not affect a loop formed by the first capacitor C21 and the output terminal of the first discharging branch, a voltage still exists at the output terminal of the first discharging branch. To avoid a safety hazard of the switched-mode power supply circuit, in this embodiment, in a case where the secondary control circuit 23 detects that no load is electrically connected to the output terminal of the first discharging branch, while controlling the first switch circuit S21 of the first discharging branch to be in non-conduction, the secondary control circuit 23 further transmits a control signal to the first discharge circuit 24 to control the first discharge circuit 24 to be in conduction, such that the first discharge circuit 24 and the first capacitor C21 may form a current discharge path to release the energy stored in the first capacitor C21, thereby pulling down the voltage at the first terminal of the first capacitor C21, preventing the output terminal of the first discharging branch from being energized, and ensuring safety of the switched-mode power supply circuit.

The circuit structures and operating principles of the second discharging branch and other discharging branches according to this embodiment are the same as those of the first discharging branch, which are not described herein any further.

Through a comparative analysis between the switched-mode power supply circuit according to this embodiment and the switched-mode power supply circuit in the related art in FIG. 1, it may be known that in the switched-mode power supply circuit according to this embodiment, a discharge circuit is disposed on each discharging branch. In a case where no load is electrically connected to the output terminal of a discharging branch, the secondary control circuit controls the discharge circuit to be in conduction, to bleed off the residual charge in the discharging branch. This prevents the output terminal of the discharging branch from being energized, and ensures operational safety and stability of the switched-mode power supply circuit. By arranging a discharge circuit, the present disclosure achieves the technical effects of the load switch, the controller, and the filter circuit in the related art, thereby simplifying the circuit structure of the switched-mode power supply circuit. In this way, the hardware cost of the switched-mode power supply circuit is lower. In addition, no load switch needs to be disposed in the discharge circuit according to the present disclosure. This prevents thermal loss generated during operation of the load switch, and improves the overall operational efficiency of the switched-mode power supply circuit.

Still referring to FIG. 2, in an embodiment, the switched-mode power supply circuit further includes a secondary power supply circuit 27. An input terminal of the secondary power supply circuit 27 is electrically connected to the undotted terminal of the secondary winding of the second transformer T2, and an output terminal of the secondary power supply circuit 27 is electrically connected to a power supply pin VDD of the secondary control circuit 23, such that the secondary power supply circuit 27 draws power from the undotted terminal of the secondary winding to supply power to the secondary control circuit 23.

Through a comparative analysis between the switched-mode power supply circuit according to this embodiment and the switched-mode power supply circuit in the related art in FIG. 1, it may be known that the input terminal of the secondary power supply circuit 27 supplying power to the secondary control circuit 23 according to this embodiment is disposed upstream of respective switch circuits. That is, conduction or non-conduction of the respective switch circuits does not affect the power supply to the secondary control circuit 23. This may ensure that the secondary control circuit 23 and the related peripheral circuits operate normally. Therefore, compared with the switched-mode power supply circuit in the related art, the switched-mode power supply circuit according to this embodiment may not need the load switch on each discharging branch, thereby simplifying the circuit structure and saving the hardware cost of the circuit.

In an embodiment, the secondary power supply circuit 27 according to this embodiment may adopt a low-dropout regulator (LDO). The low-dropout regulator, also known as a low-dropout linear regulator or a low-voltage-drop regulator, is a type of linear DC voltage regulator. The low-dropout regulator may provide a stable DC voltage power supply for the secondary control circuit 23. Compared with a general linear DC voltage regulator, the low-dropout regulator may operate with a smaller input-output voltage difference. Specifically, an input terminal of the low-dropout regulator is electrically connected to the undotted terminal of the secondary winding of the second transformer T2, and an output terminal of the low-dropout regulator is electrically connected to a power supply terminal of the secondary control circuit 23, to supply a stable operating voltage to the secondary control circuit 23.

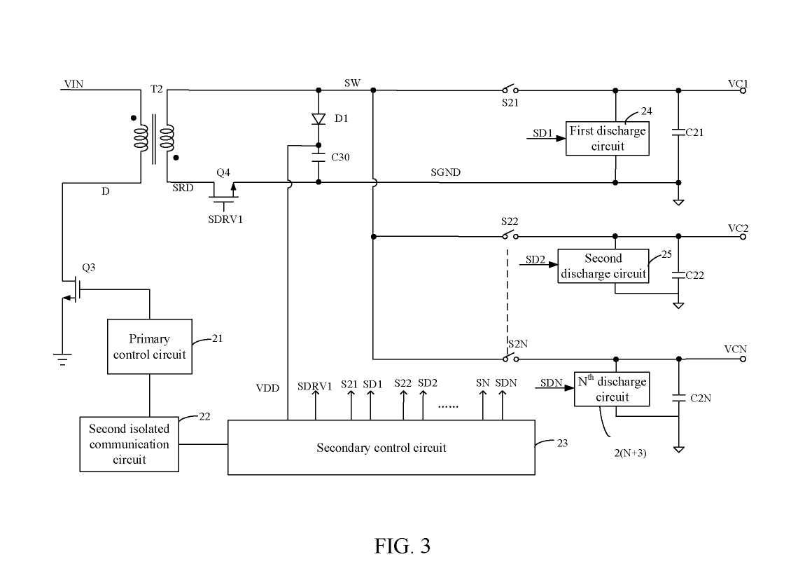

FIG. 3 is a second schematic structural diagram of a switched-mode power supply circuit according to an embodiment of the present disclosure. Referring to FIG. 3, in an embodiment, the secondary power supply circuit 27 includes a first diode D1 and a third capacitor C30. A positive terminal of the first diode D1 is electrically connected to the undotted terminal of the secondary winding, a negative terminal of the first diode D1 is electrically connected to a first terminal of the third capacitor C30, and a second terminal of the third capacitor C30 is grounded. The first terminal of the third capacitor C30 is further electrically connected to the power supply pin VDD of the secondary control circuit 23.

During operation, energy of a voltage spike at the undotted terminal SW of the secondary winding is transmitted to the third capacitor C30 via the first diode D1 for storage, such that the energy stored in the third capacitor C30 can be supplied to the secondary control circuit 23. This not only eliminates the voltage spike in a secondary loop to ensure stability of a discharge voltage outputted by the switched-mode power supply circuit, but also uses the energy of the voltage spike to supply power to the secondary control circuit 23, thereby improving an energy conversion efficiency of the switched-mode power supply circuit.

It may be understood that, in this embodiment, for the secondary power supply circuit 27 composed of the first diode D1 and the third capacitor C30, during an interval where the second transformer T2 transmits energy to the secondary loop within a switching cycle, all discharging branches may be controlled to be in non-conduction for a period of time depending on an amount of energy required by the secondary power supply circuit 27. In this case, the energy in the second transformer T2 may flow to the third capacitor C30 via the first diode D1 and may be stored in the third capacitor C30. In a case where a discharging branch is electrically connected to a load and is turned on, the energy in the second transformer T2 may flow to the corresponding discharging branch, and maintain the voltage at the output terminal of the discharging branch stable at a target value.

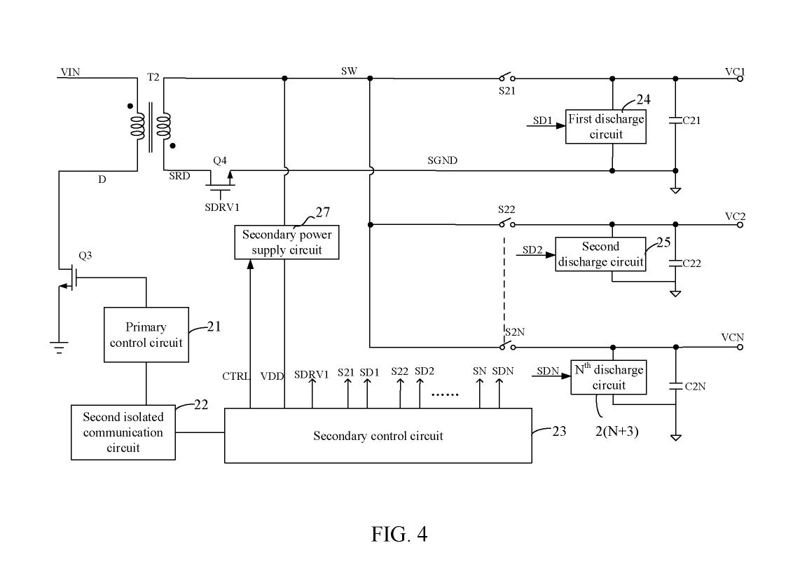

FIG. 4 is a third schematic structural diagram of a switched-mode power supply circuit according to an embodiment of the present disclosure. Referring to FIG. 4, in an embodiment, the secondary control circuit 23 further includes a control pin CTRL, and the control pin CTRL is electrically connected to a control terminal of the secondary power supply circuit 27. The secondary control circuit 23 is further configured to, in response to detecting that a voltage value at the power supply pin VDD reaches a first predetermined voltage, transmit a first control signal to the secondary power supply circuit 27 via the control pin CTRL; and the secondary power supply circuit 27 is configured to stop supplying power to the secondary control circuit 23 in response to the first control signal.

It may be understood that, in an application scenario, during a startup process of the switched-mode power supply circuit, respective discharging branches are all in a non-conduction state. In this case, all the energy in the second transformer T2 is transferred to the secondary power supply circuit 27, and the voltage at the power supply pin VDD of the secondary control circuit 23 may gradually rise. In a case where the voltage at the power supply pin VDD of the secondary control circuit 23 is higher than an operating voltage, the secondary control circuit 23 starts to operate. The secondary control circuit 23 controls the switch circuit on the discharging branch connected to a load, such that the second transformer T2 outputs energy to the corresponding discharging branch. In response to detecting that the voltage of the power supply pin VDD reaches or is higher than the first predetermined voltage, the secondary control circuit 23 transmits the first control signal to the secondary power supply circuit 27 via the control pin CTRL. In response to the first control signal, the secondary power supply circuit 27 controls the secondary power supply circuit 27 to be in non-conduction, to stop continuously supplying power to the secondary control circuit 23.

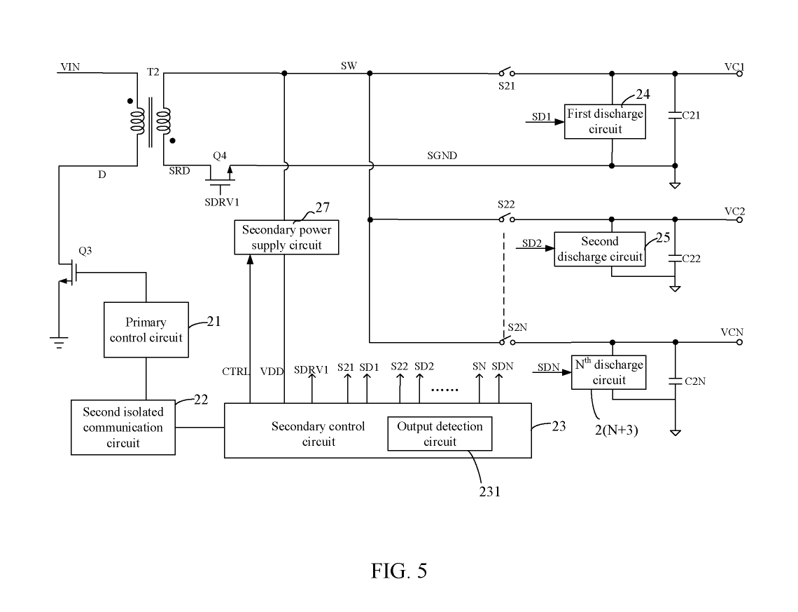

FIG. 5 is a fourth schematic structural diagram of a switched-mode power supply circuit according to an embodiment of the present disclosure. Referring to FIG. 5, in an embodiment, the switched-mode power supply circuit further includes an output detection circuit 231. Sampling terminals of the output detection circuit 231 are respectively electrically connected to the output terminal of each discharging branch, and an output terminal of the output detection circuit 231 is electrically connected to the secondary control circuit 23. The output detection circuit 231 is configured to detect whether a load is electrically connected to the output terminal of the discharging branch, and output a detection result to the secondary control circuit 23; and the secondary control circuit 23 is configured to, in response to detecting that no load is electrically connected to the output terminal of the discharging branch, control the switch circuit on the discharging branch to be in non-conduction, and simultaneously control the discharge circuit on the discharging branch to be in conduction, to bleed off the residual charge in the discharging branch. This prevents the output terminal of the discharging branch from being energized, and ensures operational safety and stability of the switched-mode power supply circuit.

The output detection circuit 231 according to this embodiment is further configured to determine whether a load is electrically connected to the output terminal of each discharging branch by detecting a magnitude of an impedance at the output terminal of the discharging branch. Given that the output detection circuit 231 is a commonly used and mature functional circuit in the circuit field, it is easy to implement for a person skilled in the circuit field, which is not described herein any further.

In an embodiment, the output detection circuit 231 is further configured to detect a load voltage at the output terminal of each discharging branch, and output a detection result to the secondary control circuit 23; and the secondary control circuit 23 is further configured to, in response to detecting that the load voltage at the output terminal of a discharging branch reaches a corresponding voltage threshold, control the switch circuit on the discharging branch to be in non-conduction, and simultaneously control the discharge circuit on the discharging branch to be in conduction, to bleed off the residual charge in the discharging branch, which prevents the output terminal of the discharging branch from being energized. In this way, an operating state of the switched-mode power supply circuit may be monitored in real time, and safety of the operation of the switched-mode power supply circuit is ensured.

In an embodiment, the output detection circuit 231 is further configured to detect a load current at the output terminal of each discharging branch, and output a detection result to the secondary control circuit 23; and the secondary control circuit 23 is further configured to, in response to detecting that the load current at the output terminal of a discharging branch reaches a corresponding current threshold, control the switch circuit on the discharging branch to be in non-conduction, and simultaneously control the discharge circuit on the discharging branch to be in conduction, to bleed off the residual charge in the discharging branch, which prevents the output terminal of the discharging branch from being energized. In this way, an operating state of the switched-mode power supply circuit may be monitored in real time, and safety of the operation of the switched-mode power supply circuit is ensured.

In an embodiment, the output detection circuit 231 is further configured to detect a load voltage and a load current at the output terminal of each discharging branch, and output a detection result to the secondary control circuit 23; and the secondary control circuit 23 is further configured to, in response to detecting that the load voltage or the load current at the output terminal of a discharging branch reaches a corresponding threshold, control the switch circuit on the discharging branch to be in non-conduction, and simultaneously control the discharge circuit on the discharging branch to be in conduction, to bleed off the residual charge in the discharging branch, which prevents the output terminal of the discharging branch from being energized. In this way, an operating state of the switched-mode power supply circuit may be monitored in real time, and safety of the operation of the switched-mode power supply circuit is ensured.

In an embodiment, the output detection circuit 231 is further configured to detect whether an anomaly occurs on each discharging branch, and output a detection result to the secondary control circuit 23; and the secondary control circuit 23 is further configured to, in response to detecting that the output terminal of a discharging branch is abnormal, control the switch circuit on the discharging branch to be in non-conduction, and simultaneously control the discharge circuit on the discharging branch to be in conduction, to bleed off the residual charge in the discharging branch, which prevents the output terminal of the discharging branch from being energized. In this way, an operating state of the switched-mode power supply circuit may be monitored in real time, and safety of the operation of the switched-mode power supply circuit is ensured.

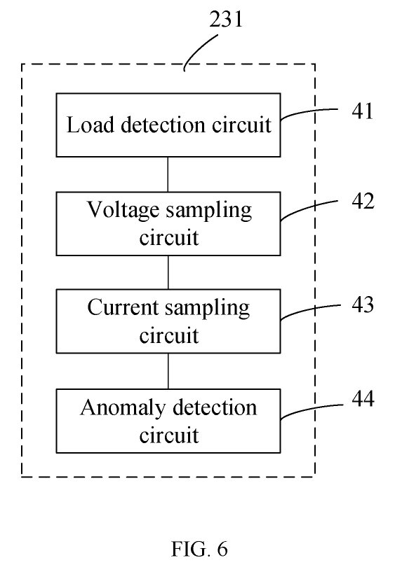

FIG. 6 is a schematic structural diagram of an output detection circuit according to an embodiment of the present disclosure. Referring to FIG. 6, it may be understood that, in an embodiment, the output detection circuit 231 may include a load detection circuit 41, a voltage sampling circuit 42, a current sampling circuit 43, and an anomaly detection circuit 44, to detect whether a load is electrically connected to an output terminal of the switched-mode power supply circuit, detect a load voltage at the output terminal of the switched-mode power supply circuit, detect a load current at the output terminal of the switched-mode power supply circuit, and detect an abnormal operating state at the output terminal of the switched-mode power supply circuit.

The voltage sampling circuit 42 according to this embodiment may adopt a common voltage sampling circuit structure in the field of sampling circuits. For example, in some embodiments, a voltage sampling circuit composed of a sampling resistor and an amplifier may be adopted, where a voltage signal is converted into a current signal through the sampling resistor, and then amplified by the amplifier to satisfy a requirement on the input voltage range of a microcontroller. Specific circuit designs include using resistor voltage division and an operational amplifier to realize calculation of a voltage amplification gain. In other embodiments, a Hall sensor circuit may also be adopted to implement voltage sampling. The Hall sensor may directly measure a high-voltage signal and convert the high-voltage signal into a voltage signal.

It should be noted that, in a switched-mode power supply circuit having a plurality of outputs, in order to enable the output detection circuit 231 to simultaneously detect states of output terminals of the discharging branches, the output detection circuit 231 has a plurality of groups of detection terminals, wherein each group of detection terminals is electrically connected to an output terminal of one discharging branch; or the output detection circuit 231 includes a plurality of output detection sub-circuits, wherein each output detection sub-circuit may detect a state of an output terminal of one discharging branch, such that the output detection circuit 231 is capable of detecting the states of the output terminals of the discharging branches.

Exemplarily, in a switched-mode power supply circuit having a plurality of outputs, in order to enable the load detection circuit 41 to detect whether a load is electrically connected to the output terminals of the discharging branches, the load detection circuit 41 has a plurality of groups of sampling terminals, wherein each group of sampling terminals is electrically connected to the output terminal of one discharging branch; or the load detection circuit 41 includes a plurality of load detection sub-circuits, wherein each load detection sub-circuit may detect whether a load is electrically connected to one discharging branch, such that the load detection circuit 41 is capable of detecting whether the load is electrically connected to the output terminals of the discharging branches.

It should be noted that, in a switched-mode power supply circuit having a plurality of outputs, in order to enable the voltage sampling circuit 42 to sample a voltage value at the output terminals of the discharging branches, the voltage sampling circuit 42 has a plurality of groups of sampling terminals, wherein each group of sampling terminals is electrically connected to the output terminal of one discharging branch; or the voltage sampling circuit 42 includes a plurality of voltage sampling sub-circuits, wherein each voltage sampling sub-circuit may sample a voltage at the output terminal of one discharging branch, such that the voltage sampling circuit 42 is capable of sampling the voltage at the output terminals of the discharging branches.

Correspondingly, in order to enable the current sampling circuit 43 to sample a current value at the output terminals of the discharging branches, the current sampling circuit 43 has a plurality of groups of sampling terminals, wherein each group of sampling terminals is electrically connected to the output terminal of one discharging branch; or the current sampling circuit 43 includes a plurality of current sampling sub-circuits, wherein each current sampling sub-circuit may sample a current at the output terminal of one discharging branch, such that the current sampling circuit 43 is capable of sampling the current at the output terminals of the respective discharging branches. The anomaly detection circuit 44 may also have a plurality of sampling terminals to implement sampling of an anomaly at the output terminals of the discharging branches, which is not described herein any further.

Still referring to FIG. 5, in an embodiment, the output detection circuit 231 may be integrated into the secondary control circuit 23 to facilitate design and production, and improve production efficiency.

Still referring to FIG. 2, generally, the switched-mode power supply circuit according to this embodiment further includes a second isolated communication circuit 22. The primary control circuit 21 is electrically connected to the secondary control circuit 23 via the second isolated communication circuit 22. It may be understood that, during operation of the circuit, the second isolated communication circuit 22 mainly achieves effects in terms of safety, stability, and noise isolation to ensure stable operation of the circuit, which is not described herein any further.

In an embodiment, the secondary control circuit 23 is further configured to, in a case where no load is electrically connected to the output terminals of all discharging branches, determine whether a voltage value at a power supply pin VDD of the secondary control circuit 23 is greater than a first predetermined voltage, and output a second control signal to the primary control circuit 21 via the second isolated communication circuit 22 in a case where the voltage value at the power supply pin VDD of the secondary control circuit 23 is greater than the first predetermined voltage; and the primary control circuit 21 is configured to control the primary transistor Q3 to be turned off in response to the second control signal, to stop outputting energy to the secondary control circuit 23.

In an embodiment, the secondary control circuit 23 is further configured to, in a case where no load is electrically connected to the output terminals of all discharging branches, determine whether the voltage value at the power supply pin VDD of the secondary control circuit 23 is less than a second predetermined voltage, and output a third control signal to the primary control circuit 21 via the second isolated communication circuit 22 in a case where the voltage value at the power supply pin VDD of the secondary control circuit 23 is less than the second predetermined voltage; and the primary control circuit 21 is configured to control the primary transistor Q3 to be turned on in response to the third control signal, to output energy to the secondary control circuit 23.

In an embodiment, in response to detecting that a load is electrically connected to each of the output terminals of the first discharging branch and the second discharging branch, the secondary control circuit 23 controls an on-time duty ratio of the switch circuit on the first discharging branch based on an energy ratio required by the load at the output terminal of the first discharging branch and an on-time duty ratio of the switch circuit on the second discharging branch based on an energy ratio required by the load at the output terminal of the second discharging branch respectively, to adjust a discharge power at the output terminal of each discharging branch. Specifically, an on-time of a corresponding switch circuit is longer for a discharging branch requiring greater energy for the load. In this way, dual outputs may simultaneously charge electronic devices.

In an application scenario, in a case where the secondary control circuit 23 controls all discharging branches to be in a conduction state, the primary control circuit 21 is further configured to control an on-time or off-time duty ratio of the primary transistor Q3, to control the discharge power output by the discharging branches. That is, in a case where the load at the output terminal of the secondary side of the circuit is stably connected, a total discharge power outputted by the discharging branches may be controlled by controlling the on-time duty ratio of the primary transistor Q3.

In an embodiment, the switch circuit on each discharging branch includes two back-to-back disposed transistors. The back-to-back disposed transistors may prevent output energy from flowing back. For example, in a power delivery (PD ) application scenario, since the voltages output by the first discharging branch and the second discharging branch need to be adjustable, relative magnitudes of the voltages outputted on the first discharging branch and the second discharging branch may change. Therefore, the first switch circuit S21 and the second switch circuit S22 need to withstand bidirectional voltages. Therefore, in a case where the first switch circuit S21 and the second switch circuit S22 according to this embodiment are implemented by MOS transistors, due to a body diode, both the first switch circuit S21 and the second switch circuit S22 require two back-to-back MOS transistors. The two MOS transistors according to this embodiment may specifically adopt other types of power devices such as MOSFETs, GaN transistors, SiC transistors, or the like.

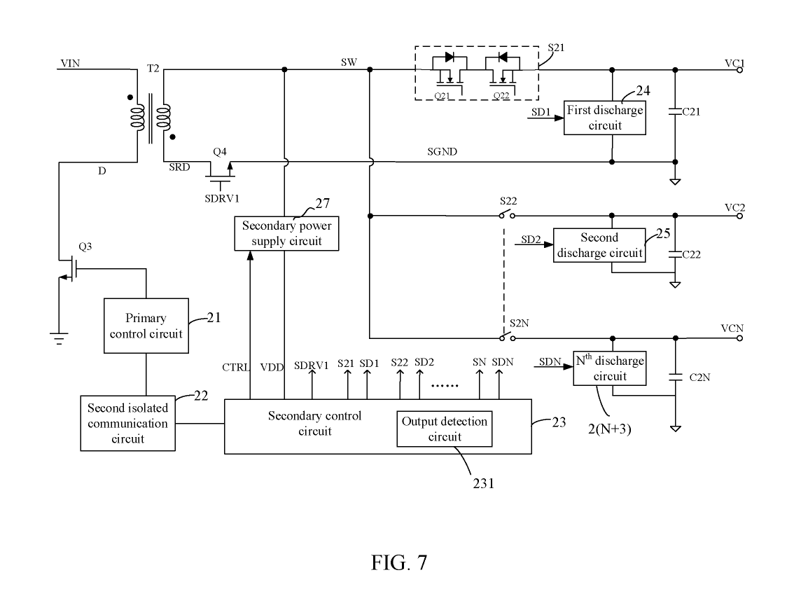

FIG. 7 is a fifth schematic structural diagram of a switched-mode power supply circuit according to an embodiment of the present disclosure. Referring to FIG. 7, in this embodiment, the first switch circuit S21 is taken as an example to illustrate the structure of the switch circuit of the present disclosure. In this embodiment, the first switch circuit S21 includes a fifth transistor Q21 and a sixth transistor Q22. A first terminal of the fifth transistor Q21 is electrically connected to an undotted terminal SW of the secondary winding of the second transformer T2, and a second terminal of the fifth transistor Q21 is electrically connected to a second terminal of the sixth transistor Q22. A first terminal of the sixth transistor Q22 is electrically connected to the first terminal of the first capacitor C21. Control terminals of the fifth transistor Q21 and the sixth transistor Q22 are both electrically connected to a drive pin on the secondary control circuit 23. The secondary control circuit 23 is configured to control the fifth transistor Q21 and the sixth transistor Q22 to be turned on or turned off, thereby controlling the first discharging branch to be in conduction or in non-conduction.

The fifth transistor Q21 and the sixth transistor Q22 in the first switch circuit S21 according to this embodiment may adopt NMOS transistors, and specifically may be MOSFETs, GaN transistors, or SiC transistors, or the like. In other embodiments, the fifth transistor Q21 and the sixth transistor Q22 may also adopt PMOS transistors. For example, in a case where the fifth transistor Q21 and the sixth transistor Q22 according to this embodiment adopt NMOS transistors, first terminals thereof are sources, second terminals thereof are drains, and control terminals thereof are gates.

In other embodiments, the two back-to-back transistors in the first switch circuit S21 and the second switch circuit S22 may also be replaced by bidirectional switches. The bidirectional switch may also prevent output energy from flowing back.

Since the switch circuit structures on the discharging branches are the same in this embodiment, for switch circuit structures on other discharging branches, reference may be made to the structure of the first switch circuit S21 as described above, which are not described herein any further.

In an embodiment, the discharge circuit on each discharging branch may include a controllable switch and a resistor. For example, the controllable switch and the resistor are connected in series between the output terminal of the discharging branch and the ground. By controlling the controllable switch to be closed (turned on), the controllable switch and the resistor form a current discharge path, thereby pulling down a voltage at a positive terminal of the discharging branch.

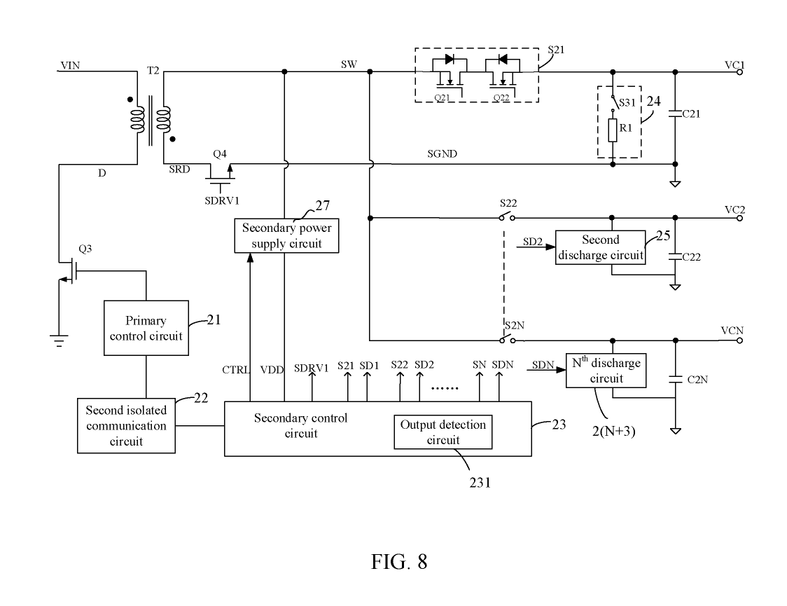

FIG. 8 is a sixth schematic structural diagram of a switched-mode power supply circuit according to an embodiment of the present disclosure. Referring to FIG. 8, this embodiment takes the structure of the first discharge circuit 24 as an example. The first discharge circuit 24 on the first discharging branch according to this embodiment includes a third switch S31 and a first resistor R1. A first terminal of the third switch S31 is electrically connected to the first terminal of the first capacitor C21, a second terminal of the third switch S31 is electrically connected to a first terminal of the first resistor R1, a second terminal of the first resistor R1 is grounded, and a control terminal of the third switch S31 is electrically connected to a drive pin on the secondary control circuit 23. The secondary control circuit 23 may control the third switch S31 to be turned on or turned off. In a case where the third switch S31 is closed (that is, the third switch S31 is turned on), the third switch S31 and the first resistor R1 may form a current discharge path to pull down the voltage at the first terminal of the first capacitor C21, thereby pulling down the voltage on the first discharging branch.

Since the discharge circuit structures on the discharging branches are the same in this embodiment, for discharge circuit structures on other discharging branches, reference may be made to the structure of the first discharge circuit 24 as described above, which are not described herein any further.

It should be noted that, in all the above embodiments, a low-side synchronous rectification structure is mainly used to illustrate the solutions of the present disclosure, that is, the secondary transistor Q4 (also referred to as a synchronous rectification transistor) according to all the embodiments is disposed between the dotted terminal of the secondary winding of the second transformer T2 and the output ground. In other embodiments, the technical solutions according to the present disclosure may also be applied to a high-side synchronous rectification scenario, that is, the secondary transistor Q4 according to all the embodiments is disposed at the undotted terminal of the second transformer T2, and specifically disposed between the undotted terminal in the figure and the point SW in the figures. In this way, the technical solutions according to the present disclosure and the technical effects of the discharging branches are exactly the same as those of the low-side synchronous rectification structure. For details, reference may be made to the above embodiments, which are not described herein any further.

An embodiment of the present disclosure further provides a secondary control circuit, which may be applied to the switched-mode power supply circuits according to the above embodiments. The secondary control circuit according to this embodiment may correspond to the secondary control circuit according to the above embodiments. Specific circuit connection relationships, operating procedures, and technical effects are not described herein any further.

In an embodiment, the secondary control circuit 23 is configured to, in response to detecting that no load is electrically connected to an output terminal of a target discharging branch, control the switch circuit on the target discharging branch to be in non-conduction, and simultaneously control the discharge circuit on the target discharging branch to be in conduction, such that the residual charge in the target discharging branch is bled off. In other words, the secondary control circuit 23 is configured to, in response to detecting that no load is electrically connected to the output terminal of the discharging branch, control the switch circuit on the discharging branch to be in non-conduction, and simultaneously control the discharge circuit on the discharging branch to be in conduction, to bleed off the residual charge in the discharging branch. This prevents the output terminal of the discharging branch from being energized, and ensures operational safety and stability of the switched-mode power supply circuit.

In an embodiment, the secondary control circuit 23 is further configured to: acquire a load condition at the output terminal of each discharging branch of the at least one discharging branch, determine an energy ratio required by the each discharging branch electrically connected to a load, and control an on-time duty ratio of the switch circuit on the each discharging branch electrically connected to the load based on the energy ratio, to adjust a discharge power at the output terminal of the each discharging branch. For example, in response to detecting that a load is electrically connected to each of the output terminals of the first discharging branch and the second discharging branch, the secondary control circuit 23 controls an on-time duty ratio of the switch circuit on the first discharging branch and the second discharging branch based on an energy ratio required by the load at the output terminals of the first discharging branch and the second discharging branch respectively, to adjust a discharge power at the output terminal of each discharging branch. Specifically, an on-time of a corresponding switch circuit is longer for a discharging branch requiring greater energy for the load. In this way, dual outputs may simultaneously charge electronic devices.

In an embodiment, the secondary control circuit 23 is further configured to, in a case where no load is electrically connected to the output terminals of all discharging branches, determine whether a voltage value at a power supply pin VDD of the secondary control circuit 23 is greater than a first predetermined voltage, and output a second control signal to the primary control circuit 21 via the second isolated communication circuit 22 in a case where the voltage value at the power supply pin VDD of the secondary control circuit 23 is greater than the first predetermined voltage; and the primary control circuit 21 is configured to control the primary transistor Q3 to be turned off in response to the second control signal, to stop outputting energy to the secondary control circuit 23.

In an embodiment, the secondary control circuit 23 is further configured to, in a case where no load is electrically connected to the output terminals of all discharging branches, determine whether the voltage value at the power supply pin VDD of the secondary control circuit 23 is less than a second predetermined voltage, and output a third control signal to the primary control circuit 21 via the second isolated communication circuit 22 in a case where the voltage value at the power supply pin VDD of the secondary control circuit 23 is less than the second predetermined voltage; and the primary control circuit 21 is configured to control the primary transistor Q3 to be turned on in response to the third control signal, to output energy to the secondary control circuit 23.

In an application scenario, in a case where the secondary control circuit 23 controls all discharging branches to be in a conduction state, the primary control circuit 21 is further configured to control an on-time or off-time duty ratio of the primary transistor Q3, to control the discharge power output by the discharging branches. That is, in a case where the load at the output terminal of the secondary side of the circuit is stably connected, a total discharge power outputted by the discharging branches may be controlled by controlling the on-time duty ratio of the primary transistor Q3.

An embodiment of the present disclosure further provides a chip. The chip includes the switched-mode power supply circuit as described above, or the chip includes the secondary control circuit 23 as described above.

An embodiment of the present disclosure further provides an electronic device. The electronic device includes the switched-mode power supply circuit as described above, or the chip as described above. It may be understood that the electronic device may be a power adapter having a plurality of output terminals, or the electronic device may also be a portable power bank having a plurality of output terminals, or the like.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A switched-mode power supply circuit, comprising:
a transformer, a secondary control circuit, a secondary transistor, and at least one discharging branch; wherein
a primary winding of the transformer is configured to receive a supply voltage, a first terminal of a secondary winding of the transformer is electrically connected to an input terminal of each discharging branch of the at least one discharging branch, and an output terminal of the each discharging branch is configured to output a respective discharge voltage;
a second terminal of the secondary winding is electrically connected to a first terminal of the secondary transistor, a second terminal of the secondary transistor is grounded, and a control terminal of the secondary transistor is electrically connected to the secondary control circuit;
any one discharging branch of the at least one discharging branch comprises a switch circuit, an energy storage capacitor, and a discharge circuit, wherein a first terminal of the switch circuit serves as the input terminal of the discharging branch, a second terminal of the switch circuit serves as the output terminal of the discharging branch, a control terminal of the switch circuit is electrically connected to the secondary control circuit, and the secondary control circuit is configured to control the switch circuit to be in conduction or in non-conduction;
a first terminal of the energy storage capacitor is electrically connected to the second terminal of the switch circuit, and a second terminal of the energy storage capacitor is grounded; an input terminal of the discharge circuit is electrically connected to the first terminal of the energy storage capacitor, an output terminal of the discharge circuit is grounded, and a control terminal of the discharge circuit is electrically connected to the secondary control circuit; and
the secondary control circuit is configured to, in response to determining that no load is electrically connected to the output terminal of the discharging branch, control the discharge circuit to be in conduction to pull down a voltage at the output terminal of the discharging branch.

2. The switched-mode power supply circuit according to claim 1, wherein the switched-mode power supply circuit further comprises a secondary power supply circuit; wherein an input terminal of the secondary power supply circuit is electrically connected to the first terminal of the secondary winding, and an output terminal of the secondary power supply circuit is electrically connected to a power supply pin of the secondary control circuit; and
the secondary power supply circuit is configured to draw power from the first terminal of the secondary winding to supply power to the secondary control circuit.

3. The switched-mode power supply circuit according to claim 2, wherein the secondary control circuit further comprises a control pin, wherein the control pin is electrically connected to a control terminal of the secondary power supply circuit;
the secondary control circuit is further configured to, in response to detecting that a voltage value at the power supply pin reaches a first predetermined voltage, transmit a first control signal to the secondary power supply circuit via the control pin; and
the secondary power supply circuit is configured to stop supplying power to the secondary control circuit in response to the first control signal.

4. The switched-mode power supply circuit according to claim 2, wherein the secondary power supply circuit comprises a first diode and a third capacitor; wherein a positive terminal of the first diode is electrically connected to the first terminal of the secondary winding, a negative terminal of the first diode is electrically connected to a first terminal of the third capacitor, and a second terminal of the third capacitor is grounded; and
the first terminal of the third capacitor is further electrically connected to a power supply terminal of the secondary control circuit.

5. The switched-mode power supply circuit according to claim 1, further comprising:
an output detection circuit; wherein sampling terminals of the output detection circuit are respectively electrically connected to the output terminal of the each discharging branch, and an output terminal of the output detection circuit is electrically connected to the secondary control circuit;
the output detection circuit is configured to detect whether a load is electrically connected to the output terminal of the discharging branch, and output a detection result to the secondary control circuit; and
the secondary control circuit is configured to, in response to determining that no load is electrically connected to the output terminal of the discharging branch, control the switch circuit on the discharging branch to be in non-conduction, and control the discharge circuit on the discharging branch to be in conduction.

6. The switched-mode power supply circuit according to claim 5, wherein the output detection circuit is further configured to detect at least one of a load voltage and a load current at the output terminal of the discharging branch, and then output a detection result to the secondary control circuit; and
the secondary control circuit is further configured to, in response to determining that the at least one of the load voltage and the load current reaches a corresponding threshold, control the switch circuit on the discharging branch to be in non-conduction, and simultaneously control the discharge circuit on the discharging branch to be in conduction.

7. The switched-mode power supply circuit according to claim 5, wherein the output detection circuit is further configured to detect whether an anomaly occurs on the discharging branch, and output a detection result to the secondary control circuit; and
the secondary control circuit is further configured to, in response to detecting that the output terminal of the discharging branch is abnormal, control the switch circuit on the discharging branch to be in non-conduction, and simultaneously control the discharge circuit on the discharging branch to be in conduction, to bleed off the residual charge in the discharging branch.

8. The switched-mode power supply circuit according to claim 5, further comprising:
a primary transistor and a primary control circuit; wherein a first terminal of the primary winding of the transformer is configured to receive the supply voltage, a second terminal of the primary winding is electrically connected to a first terminal of the primary transistor, and a second terminal of the primary transistor is grounded; and a control terminal of the primary transistor is electrically connected to the primary control circuit, and the primary control circuit is configured to control the primary transistor to be turned on or turned off.

9. The switched-mode power supply circuit according to claim 8, further comprising:
an isolated communication circuit; wherein the primary control circuit is electrically connected to the secondary control circuit via the isolated communication circuit;
the secondary control circuit is further configured to, in a case where no load is electrically connected to the output terminals of all discharging branches, determine whether a voltage value at a power supply pin of the secondary control circuit is greater than a first predetermined voltage, and output a second control signal to the primary control circuit via the isolated communication circuit in a case where the voltage value at the power supply pin is greater than the first predetermined voltage; and the primary control circuit is further configured to control the primary transistor to be turned off in response to the second control signal; and
the secondary control circuit is further configured to, in a case where no load is electrically connected to the output terminals of all discharging branches, determine whether the voltage value at the power supply pin of the secondary control circuit is less than a second predetermined voltage, and output a third control signal to the primary control circuit via the isolated communication circuit in a case where the voltage value at the power supply pin is less than the second predetermined voltage; and the primary control circuit is configured to control the primary transistor to be in conduction in response to the third control signal.

10. The switched-mode power supply circuit according to claim 1, wherein the switch circuit comprises a fifth transistor and a sixth transistor; wherein a first terminal of the fifth transistor is electrically connected to the first terminal of the secondary winding of the transformer, a second terminal of the fifth transistor is electrically connected to a second terminal of the sixth transistor, and a first terminal of the sixth transistor is electrically connected to the first terminal of the energy storage capacitor; control terminals of the fifth transistor and the sixth transistor are both electrically connected to a drive pin on the secondary control circuit; and the secondary control circuit is configured to control the fifth transistor and the sixth transistor to be turned on or turned off.

11. The switched-mode power supply circuit according to claim 1, wherein the discharge circuit comprises a controllable switch and a resistor, a first terminal of the controllable switch is electrically connected to the first terminal of the energy storage capacitor, a second terminal of the controllable switch is electrically connected to a first terminal of the resistor, a second terminal of the resistor is grounded, and a control terminal of the controllable switch is electrically connected to a drive pin on the secondary control circuit; and
the secondary control circuit is configured to control the controllable switch to be in conduction or in non-conduction.

12. A secondary control circuit, applied to a switched-mode power supply circuit, wherein the switched-mode power supply circuit comprises a transformer, a secondary transistor, and at least one discharging branch; wherein a primary winding of the transformer is configured to receive a supply voltage, a first terminal of a secondary winding of the transformer is electrically connected to an input terminal of each discharging branch of the at least one discharging branch, and an output terminal of the each discharging branch is configured to output a respective discharge voltage; a second terminal of the secondary winding is electrically connected to a first terminal of the secondary transistor, a second terminal of the secondary transistor is grounded, and a control terminal of the secondary transistor is electrically connected to the secondary control circuit; any one discharging branch of the at least one discharging branch comprises a switch circuit, an energy storage capacitor, and a discharge circuit, wherein a first terminal of the switch circuit serves the input terminal of the discharging branch, a second terminal of the switch circuit serves as the output terminal of the discharging branch, and a control terminal of the switch circuit is electrically connected to the secondary control circuit; a first terminal of the energy storage capacitor is electrically connected to the second terminal of the switch circuit, and a second terminal of the energy storage capacitor is grounded; and an input terminal of the discharge circuit is electrically connected to the first terminal of the energy storage capacitor, an output terminal of the discharge circuit is grounded, and a control terminal of the discharge circuit is electrically connected to the secondary control circuit; and
the secondary control circuit is configured to, in response to detecting that no load is electrically connected to an output terminal of a target discharging branch of the at least one discharging branch, control a switch circuit on the target discharging branch to be in non-conduction, and simultaneously control a discharge circuit on the target discharging branch to be in conduction, such that residual charge in the target discharging branch is bled off.

13. The secondary control circuit according to claim 12, wherein the secondary control circuit is further configured to: acquire a load condition at the output terminal of the each discharging branch of the at least one discharging branch, determine an energy ratio required by the each discharging branch electrically connected to a load, and control an on-time duty ratio of the switch circuit on the each discharging branch electrically connected to the load based on the energy ratio, to adjust a discharge power at the output terminal of the each discharging branch.

14. The secondary control circuit according to claim 12, wherein the switched-mode power supply circuit further comprises an output detection circuit, sampling terminals of the output detection circuit are respectively electrically connected to the output terminal of the each discharging branch, and an output terminal of the output detection circuit is electrically connected to the secondary control circuit;
the output detection circuit is configured to detect at least one of a load voltage and a load current at the output terminal of the target discharging branch, and then output a detection result to the secondary control circuit; and
the secondary control circuit is further configured to, in response to determining that the at least one of the load voltage and the load current reaches a corresponding threshold, control the switch circuit on the target discharging branch to be in non-conduction, and simultaneously control the discharge circuit on the target discharging branch to be in conduction.

15. The secondary control circuit according to claim 12, wherein
the switched-mode power supply circuit further comprises an output detection circuit, sampling terminals of the output detection circuit are respectively electrically connected to the output terminal of the each discharging branch, and an output terminal of the output detection circuit is electrically connected to the secondary control circuit;
the output detection circuit is configured to detect whether an anomaly occurs on the target discharging branch, and output a detection result to the secondary control circuit; and
the secondary control circuit is further configured to, in response to detecting that the output terminal of the target discharging branch is abnormal, control the switch circuit on the target discharging branch to be in non-conduction, and simultaneously control the discharge circuit on the target discharging branch to be in conduction, to bleed off the residual charge in the target discharging branch.

16. The secondary control circuit according to claim 12, wherein
the switched-mode power supply circuit further comprises a primary transistor and a primary control circuit; wherein a first terminal of the primary winding of the transformer is configured to receive the supply voltage, a second terminal of the primary winding is electrically connected to a first terminal of the primary transistor, and a second terminal of the primary transistor is grounded; and a control terminal of the primary transistor is electrically connected to the primary control circuit, and the primary control circuit is configured to control the primary transistor to be turned on or turned off.

17. The secondary control circuit according to claim 16, wherein
the switched-mode power supply circuit further comprises an isolated communication circuit; wherein
the primary control circuit is electrically connected to the secondary control circuit via the isolated communication circuit;
the secondary control circuit is further configured to, in a case where no load is electrically connected to the output terminals of all discharging branches, determine whether a voltage value at a power supply pin of the secondary control circuit is greater than a first predetermined voltage, and output a second control signal to the primary control circuit via the isolated communication circuit in a case where the voltage value at the power supply pin is greater than the first predetermined voltage; and the primary control circuit is further configured to control the primary transistor to be turned off in response to the second control signal; and
the secondary control circuit is further configured to, in a case where no load is electrically connected to the output terminals of all discharging branches, determine whether the voltage value at the power supply pin of the secondary control circuit is less than a second predetermined voltage, and output a third control signal to the primary control circuit via the isolated communication circuit in a case where the voltage value at the power supply pin is less than the second predetermined voltage; and the primary control circuit is configured to control the primary transistor to be in conduction in response to the third control signal.

18. An electronic device, comprising:
a switched-mode power supply circuit; wherein the switched-mode power supply circuit comprises: a transformer, a primary transistor, a primary control circuit, a secondary control circuit, a secondary transistor, and at least one discharging branch;
a first terminal of the primary transistor is electrically connected to a first terminal of a primary winding of the transformer, and a second terminal of the primary winding is configured to receive a supply voltage, a second terminal of the primary transistor is grounded, and a control terminal of the primary transistor is electrically connected to the primary control circuit; wherein the primary control circuit is configured to control the primary transistor to be turned on or turned off, thereby controlling whether the primary winding outputs energy to a secondary winding of the transformer;
a first terminal of a secondary winding of the transformer is electrically connected to an input terminal of each discharging branch of the at least one of discharging branches, and an output terminal of the each discharging branch is configured to output a respective discharge voltage; a second terminal of the secondary winding of the transformer is electrically connected to a first terminal of the secondary transistor, a second terminal of the secondary transistor is grounded, and a control terminal of the secondary transistor is electrically connected to the secondary control circuit;
any one discharging branch of the at least one discharging branch comprises a switch circuit, an energy storage capacitor, and a discharge circuit, wherein a first terminal of the switch circuit serves as the input terminal of the discharging branch, a second terminal of the switch circuit serves as the output terminal of the discharging branch, a control terminal of the switch circuit is electrically connected to the secondary control circuit, and the secondary control circuit is configured to control the switch circuit to be in conduction or in non-conduction;
a first terminal of the energy storage capacitor is electrically connected to the second terminal of the switch circuit, and a second terminal of the energy storage capacitor is grounded; an input terminal of the discharge circuit is electrically connected to the first terminal of the energy storage capacitor, an output terminal of the discharge circuit is grounded, and a control terminal of the discharge circuit is electrically connected to the secondary control circuit; and
the secondary control circuit is configured to, in response to determining that no load is electrically connected to the output terminal of the discharging branch, control the discharge circuit to be in conduction to pull down a voltage at the output terminal of the discharging branch.

19. The electronic device according to claim 18, further comprising:
an output detection circuit; wherein sampling terminals of the output detection circuit are respectively electrically connected to the output terminal of the each discharging branch, and an output terminal of the output detection circuit is electrically connected to the secondary control circuit;
the output detection circuit is configured to detect whether a load is electrically connected to the output terminal of the discharging branch, and output a detection result to the secondary control circuit; and
the secondary control circuit is configured to, in response to determining that no load is electrically connected to the output terminal of the discharging branch, control the switch circuit on the discharging branch to be in non-conduction, and control the discharge circuit on the discharging branch to be in conduction.

20. The electronic device according to claim 19, wherein the output detection circuit is further configured to detect at least one of a load voltage and a load current at the output terminal of the discharging branch, and then output a detection result to the secondary control circuit; and
the secondary control circuit is further configured to, in response to determining that the at least one of the load voltage and the load current reaches a corresponding threshold, control the switch circuit on the discharging branch to be in non-conduction, and simultaneously control the discharge circuit on the discharging branch to be in conduction.
